(19) United States
(12) Patent Application Publication
(10) Pub. No.: US 2025/0293829 A1
(43) Pub. Date: Sep. 18, 2025

(54) BASE STATION DEVICE AND OPERATING METHOD OF BASE STATION DEVICE

(71) Applicant: SK TELECOM CO., LTD., Seoul (KR)

(72) Inventor: Min Soo NA, Seoul (KR)

(21) Appl. No.: 18/689,914

(22) PCT Filed: May 18, 2022
(86) PCT No.: PCT/KR2022/007116

§ 371 Date: Aug. 26, 2024

(30) Foreign Application Priority Data
Sep. 10, 2021 (KR) 10-2021-0120939

(51) Int. Cl. H04L 5/00; H04B 7/06; H04L 25/02; H04W 72/1273

(52) U.S. Cl. CPC H04L 5/0051; H04B 7/0626; H04L 25/0204; H04W 72/1273

(57) ABSTRACT

The present disclosure proposes a new adaptive channel estimation technology wherein, by reflecting the mobility of UE, accurate channel estimation based on a CSI report according to bundled CSI-RS transmission & CSI reporting regarding UE moving at high speed is possible, thereby minimizing downlink transmission performance degradation even with regard to the UE moving at high speed.

### TECHNICAL FIELD

The present disclosure relates to a technology for estimating a downlink channel by using a downlink reference signal (RS).

This application is based on and claims priority under 35 U.S.C. 119 to Korean Patent Application No. 10-2021-0120939, filed on Sep. 10, 2021, in the Korean Intellectual Property Office, the disclosure of which is herein incorporated by reference in its entirety.

### BACKGROUND ART

LTE systems have used a cell-specific RS (CRS) allocated to the entire cell as a reference signal (RS) used to identify the status of a channel between a base station and user equipment.

However, use of the CRS has limitations in that the flexibility of network configuration is limited, and energy usage is inefficient. In addition, use of the CRS is difficult to be applied to a high-frequency domain of 6 GHz or higher, and is not appropriate for multi-input multi-output (MIMO) systems using multiple antennas.

In the case of NR (5G), which uses MIMO systems and high-frequency domains, various kinds of RSs are defined according to various situations of the UE, instead of using the CRS that has been used in LTE, and RSs are exchanged according to respective beams of the MIMO, thereby evolving to be able to cope with different frequency bands and various scenarios.

Among RSs defined by 5G as described above, channel state information (CSI)-RS is an RS defined to estimate the status of a downlink channel used by a base station (gNB) for transmission to UE.

The process of downlink channel estimation using the CSI-RS will be described briefly: when the gNB transmits the CSI-RS, the UE identifies/recognizes the status (situation) of the downlink channel on the basis of the received CSI-RS, and reports the result (CSI) to the gNB.

The gNB then conducts a procedure of estimating the status (situation) of the downlink channel with the UE on the basis of the received CSI report. The gNB may then perform downlink scheduling (for example, modulation scheme, code rate, the number of transmission layers, MIMO precoding, and the like) based on channel estimation through the CSI report with regard to the UE.

Meanwhile, when the UE is moving at high speed, the downlink channel environment becomes unstable, and this may cause a problem in that the transmission performance according to downlink scheduling based on channel estimation through the CSI report is degraded.

However, current standards fail to provide a scheme for implementing accurate channel estimation based on the CSI report even in the environment in which the UE is moving at high speed.

The present disclosure thus seeks to propose a new type of adaptive channel estimation technology reflecting the mobility of the UE wherein accurate channel estimation based on the CSI is possible even if the UE is moving at high speed.

### DISCLOSURE OF INVENTION

### Technical Problem

The present disclosure seeks to implement a new type of adaptive channel estimation technology by reflecting the mobility of the UE wherein accurate channel estimation based on the CSI is possible even if in an environment in which the UE is moving at high speed.

### Solution to Problem

A base station device according to an embodiment of the present disclosure includes: a reference signal multi-transmission unit configured to transmit multiple specific reference signals (RSs) over a consecutive period of time; and a control unit configured to receive multiple pieces of channel state information reported on the basis of the specific RSs, respectively, from UE which has received the multiple specific RSs transmitted such that the multiple pieces of channel state information are used for channel estimation regarding the UE.

Specifically, transmission of the multiple specific RSs and reporting of the multiple pieces of channel state information may be activated by a specific identifier transmitted through a field predefined inside configuration information related to the specific RSs, or an additionally defined specific field.

Specifically, the reference signal multi-transmission unit may transmit the specific RSs through identical radio resources inside multiple slots over the consecutive period of time such that multiple specific RSs are transmitted over the consecutive period of time.

Specifically, transmission of the multiple specific RSs and reporting of the multiple pieces of channel state information may be activated according to the speed at which the UE is moving, or activated according to a change in transmission performance according to downlink scheduling based on channel estimation regarding the UE.

Specifically, the number of the multiple specific RSs transmitted and the multiple pieces of channel state information reported may be larger in proportion to the speed at which the UE is moving than when the UE is moving at low speed, or larger in proportion to degradation in transmission performance according to downlink scheduling based on channel estimation regarding the UE than when the performance degradation is less.

A method for operating a base station device according to an embodiment of the present disclosure includes: a reference signal multi-transmission operation of transmitting multiple specific reference signals (RSs) over a consecutive period of time; and a multi-report reception operation of receiving multiple pieces of channel state information reported on the basis of the specific RSs, respectively, from UE which has received the multiple specific RSs transmitted such that the multiple pieces of channel state information are used during channel estimation regarding the UE.

Specifically, transmission of the multiple specific RSs and reporting of the multiple pieces of channel state information may be activated by a specific identifier transmitted through a field predefined inside configuration information related to the specific RSs, or an additionally defined specific field.

Specifically, transmission of the multiple specific RSs and reporting of the multiple pieces of channel state information may be activated according to the speed at which the UE is moving, or activated according to a change in transmission performance according to downlink scheduling based on channel estimation regarding the UE.

A user equipment device according to an embodiment of the present disclosure includes: a recognition unit configured to recognize a data transmission failure according to downlink scheduling based on channel estimation; and an information transmission unit configured to transmit, when recognizing the data transmission failure, channel state information regarding a downlink channel to a base station through the fastest uplink channel at the recognition timepoint such that the base station performs downlink scheduling based on channel estimation by using the channel state information.

Specifically, the recognition unit may recognize the data transmission failure in a frame based on the ratio of transmitted NACKs against data transmitted through a downlink channel in the frame.

Specifically, the information transmission unit may generate the channel state information on the basis of at least one of a channel state information (CSI) reference signal (RS) and a demodulate reference (DM)-RS received in a frame in which the data transmission failure is recognized.

Specifically, the fastest uplink channel at the recognition timepoint may be defined as a reserved channel inside a physical uplink control channel (PUCCH) or physical uplink shared channel (PUSCH) in a frame in which the data transmission failure is recognized.

A method for operating a user equipment device according to an embodiment of the present disclosure includes: a recognition operation of recognizing a data transmission failure according to downlink scheduling based on channel estimation; and an information transmission operation of transmitting, when recognizing the data transmission failure situation, channel state information regarding a downlink channel to a base station through the fastest uplink channel at the recognition timepoint such that the base station performs downlink scheduling based on channel estimation by using the channel state information.

Specifically, in the recognition operation, the data transmission failure may be recognized based on the ratio of transmitted NACKs against data transmitted through a downlink channel in a frame.

Specifically, in the information transmission operation, the channel state information may be generated on the basis of at least one of channel state information (CSI) reference signal (RS) and a demodulate reference (DM)-RS received in a frame in which the data transmission failure is recognized.

Specifically, the fastest uplink channel at the recognition timepoint may be defined as a reserved channel in a physical uplink control channel (PUCCH) or physical uplink shared channel (PUSCH) in a frame in which the data transmission failure is recognized.

### Advantageous Effects of Invention

A Base station device and a method for operating the base station device according to the present disclosure reflecting the mobility of the UE are advantageous in that, accurate channel estimation based on the CSI report is possible even if in an environment in which the UE is moving at high speed, thereby minimizing downlink transmission performance degradation even with regard to the UE moving at high speed.

### BRIEF DESCRIPTION OF DRAWINGS

FIG. 1 illustrates examples of reference signals to which the present disclosure is applicable.

FIG. 2 illustrates examples of port support defined for CSI-RS transmission.

FIG. 3 illustrates exemplary concepts regarding conventional CSI-RS transmission and CSI reporting schemes.

FIG. 4 illustrates exemplary concepts regarding bundled CSI-RS transmission and bundled CSI reporting proposed by the present disclosure.

FIG. 5 is a block diagram illustrating components of a gNB device according to an embodiment of the present disclosure.

FIG. 6 is a flowchart illustrating a method for operating a gNB device according to an embodiment of the present disclosure.

FIG. 7 illustrates exemplary concept regarding a conventional CSI reporting scheme.

FIG. 8 illustrates exemplary concept regarding UE-initiated adaptive CSI reporting (UE-initiated CSI feedback) proposed by the present disclosure.

FIG. 9 is a block diagram illustrating components of a UE device according to an embodiment of the present disclosure.

FIG. 10 is a flowchart illustrating a method for operating a UE device according to an embodiment of the present disclosure.

### BEST MODE FOR CARRYING OUT THE INVENTION

Hereinafter, various embodiments of the present disclosure will be described with reference to the attached drawings.

The present disclosure relates to a downlink channel estimation technology using a downlink reference signal (RS).

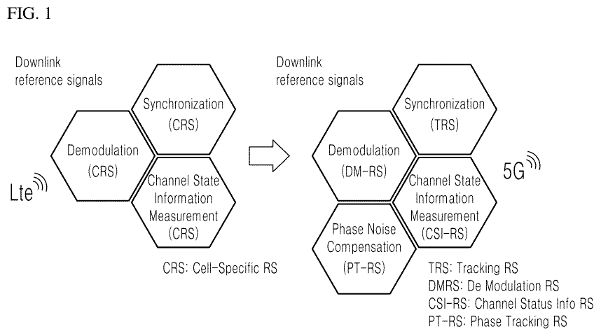

As illustrated in FIG. 1, LTE systems have used, as a reference signal (RS) used to know the status of a channel between a gNB and UE, a cell-specific RS (CRS) allocated to the entire cell.

However, such CRS use has limitations in that the flexibility of network configuration is limited, and energy usage is inefficient. In addition, use of the CRS is difficult to be applied to a high-frequency domain of 6 GHz or higher, and is not appropriate for multi-input multi-output (MIMO) systems using multiple antennas.

In the case of NR (5G), which uses MIMO systems and high-frequency domains, various kinds of RSs such as s tracking RS (TRS), a demodulation RS (DM-RS), a channel status information-RS (CSI-RS), and a phase tracking RS (PT-RS) as illustrated in FIG. 1 are defined according to various situations of the UE, instead of using the CRS that has been used in LTE, and RSs are exchanged according to respective beams of the MIMO, thereby evolving to be able to cope with different frequency bands and various scenarios.

Simply put, the TRS is defined for time/frequency tracking and delay/Doppler spread estimation, and the DM-RS is defined for uplink/downlink channel estimation, and this enables coherent demodulation. In addition, the CSI-RS is defined for downlink channel estimation, and the PT-RS is defined for phase noise compensation in an uplink/downlink channel.

The process of downlink channel estimation using the CSI-RS among RSs defined in 5G will be described briefly: if the gNB transmits the CSI-RS, the UE identifies/recognizes the status (situation) of the downlink channel on the basis of the received CSI-RS, and reports the result (CSI) to the gNB. The gNB performs a procedure of estimating the status (situation) of the downlink channel with the UE on the basis of the received CSI report.

The CSI report transmitted from the UE to the gNB may include a layer indicator (LI), a rank indicator (RI), a precoding matrix indicator (PMI), a channel quality indicator (CQI), and the like, and may also include an SS/PBCH block resource indicator (SSBRI), an L1-RSRP, an L1-SINR, or the like.

The gNB may perform channel estimation on the basis of the CSI report with regard to the UE, and may dynamically perform downlink scheduling (for example, modulation scheme, code rate, the number of transmission layers, MIMO precoding, and the like) on the basis of such channel estimation.

Meanwhile, if the UE is moving at high speed, the downlink channel environment becomes unstable due to the environment in which the UE is moving at high speed, and this may cause a problem in that the transmission performance is degraded due to downlink scheduling based on channel estimation through the CSI report.

However, current standards fail to provide a scheme for implementing accurate channel estimation based on the CSI report even in the environment in which the UE is moving at high speed.

The present disclosure thus seeks to propose a new type of adaptive channel estimation technology wherein, by reflecting the mobility of the UE, accurate channel estimation based on the CSI report is possible even if the UE is moving at high speed.

The present disclosure seeks to implement the proposed adaptive channel estimation technology by newly defining bundled CIS-RS transmission and bundled CSI reporting schemes (hereinafter, referred to as bundled CSI-RS transmission & CIS reporting) which are for adaptively performing CSI-RS transmission and CSI reporting schemes according to the mobility of the UE.

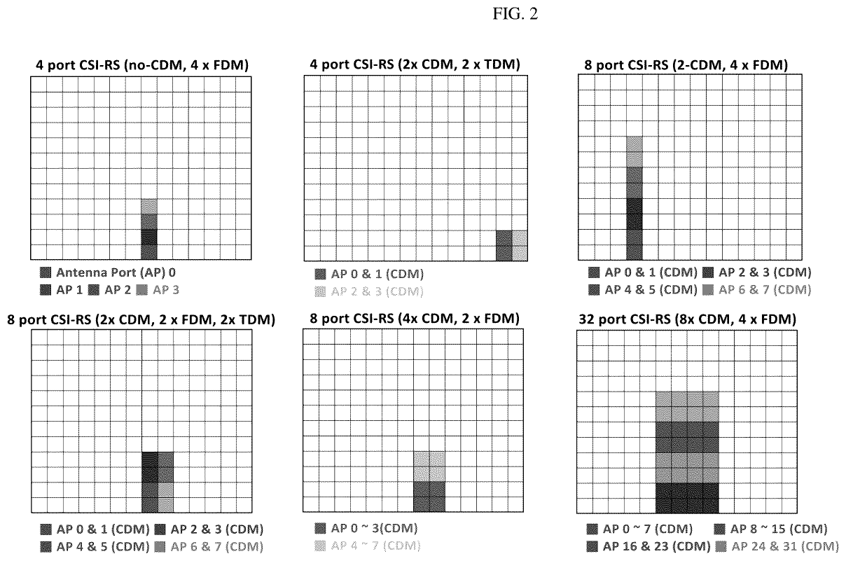

Prior to detailed description of the present disclosure, a CSI-RS-related transmission scheme will be described first with reference to FIG. 2.

Conventional LTE has used CRSs up to four ports and used CSI-RSs after four ports, but 5G (NR) may use CSI-RSs by default from one port in order to minimize inter-cell interference and overhead.

FIG. 2 illustrates examples of port use defined for CSI-RS transmission in 5G (NR).

As is clear from FIG. 2, a CRI-RS transmitted through multiple ports include orthogonal CSI-RSs, and radio resource sharing in time and frequency domains occurs through coupling of code division multiplexing (CDM), frequency division multiplexing (FDM), and time division multiplexing (TDM).

Hereinafter, adaptive bundled CSI-RS transmission & CIS reporting according to UE mobility, which are to be newly defined/implemented by the present disclosure, will be described in detail.

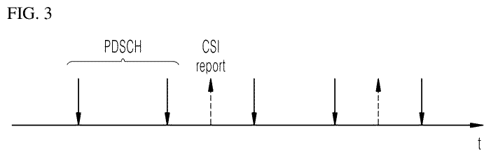

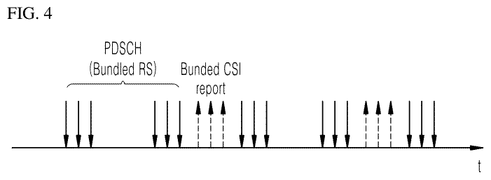

The concept regarding bundled CSI-RS transmission & CIS reporting defined by the present disclosure may be described briefly with reference to FIG. 3 and FIG. 4.

As is clear from FIG. 3, if the gNB transmits a CSI-RS by using a pre-allocated radio resource through a physical downlink shared channel (PDSCH) according to a conventional scheme, the UE receives the same and transmits a CSI periodically or aperiodically by using time and frequency radio resources mapped to a CSI-RS, thereby reporting the same.

If the UE is moving at high speed, the downlink channel environment becomes unstable due to high-speed movement environments such as the occurrence of Doppler spread resulting from the high-speed movement of the UE. Accordingly, the accuracy of channel estimation through a CSI report transmitted according to the conventional scheme is degraded inevitably.

Consequently, according to the conventional scheme, the accuracy of channel estimation through a CSI report in an environment in which the UE is moving at high speed is degraded, thereby causing a problem of degraded transmission performance due to downlink scheduling based on channel estimation through the CSI report.

Therefore, the present disclosure proposes a bundled CSI-RS transmission & CIS reporting scheme wherein, as illustrated in FIG. 4, multiple (N) CSI-RSs determined according to UE mobility are transmitted in a bundle, and multiple (M) CSIs are reported in a bundle.

That is, as is clear from FIG. 4, according to the present disclosure, the gNB transmits multiple (N) CSI-RSs in a bundle over a consecutive period of time through a PDSCH with regard to the UE which is moving at high speed.

Upon receiving the multiple (N) CSI-RSs transmitted in a bundle, the UE may report multiple (M) CSIs in a bundle to the gNB over a consecutive period of time. The multiple (M) CSIs correspond to respective results of identifying/recognizing the status (situation) of the downlink channel on the basis of respective CSI-RSs.

In this manner, according to the present disclosure, channel estimation can be performed on the basis of the bundled CSI report with regard to the UE which is moving at high speed, by reflecting the mobility of the UE, and accurate channel estimation based on the CSI report is possible even in an environment in which the UE is moving at high speed.

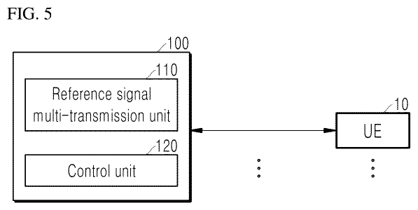

Hereinafter, components of a gNB device according to an embodiment of the present disclosure will be described in detail with reference to FIG. 5.

As illustrated in FIG. 5, the gNB device 100 according to an embodiment of the present disclosure may include a reference signal multi-transmission unit 110 and a control unit 120.

Furthermore, the gNB device 100 according to an embodiment of the present disclosure may further include component of a communication unit (not illustrated) configured to communicate with nodes inside a core network, with another gNB, and with UE 10 in addition to the above-mentioned components.

The communication unit (not illustrated) includes, for example, an antenna system, an RF transceiver, one or more amplifiers, a tuner, one or more oscillators, a digital signal processor, a codec chipset, a memory, and the like, but is not limited thereto, and may include all known circuits configured to perform these functions.

All or at least some of the components of the gNB device 100 may be implemented as hardware modules, software modules, or combinations of hardware modules and software modules.

As used herein, a software module may be understood as an instruction executed by a processor that controls operations inside the gNB device 100, for example, and such an instruction may be mounted in a memory inside the gNB device 100.

Consequently, the gNB device 100 according to an embodiment of the present disclosure implements bundled CSI-RS transmission & CIS reporting to be defined by the present disclosure, through the above-mentioned components. Hereinafter, respective components of the gNB device 100 for implementing this will be described in more detail.

The reference signal multi-transmission unit 110 is configured to transmit multiple (N) specific reference signals (RSs) over a consecutive period of time.

As used herein, a specific RS refers to an RS available for downlink channel estimation in 5G (NR), and a specific example of which may be the above-mentioned CSI-RS.

That is, the reference signal multi-transmission unit 110 may transmit multiple (N) CSI-RSs over a consecutive period of time such that multiple (N) CSI-RSs are transmitted in a bundle.

To be more specific, the reference signal multi-transmission unit 110 may transmit CSI-RSs through identical pre-allocated radio resources inside multiple (for example, N) slots over a consecutive period of time in a PDSCH such that multiple (N) CSI-RSs are transmitted over a consecutive period of time (bundled transmission).

The control unit 120 is configured to receive multiple (M) pieces of channel status information (CSI) reported on the basis of respective CSI-RSs, from the UE 10 which has received multiple (N) specific RSs (for example, CSI-RSs) transmitted by the reference signal multi- transmission unit 110.

That is, if the UE 10 receives multiple (N) CSI-RSs transmitted in a bundle and reports multiple (M) CSIs in a bundle, each CSI being identified/recognized on the basis of each CSI-RS, the control unit 120 then receives the same, thereby receiving a bundled CSI report regarding a bundled CSI-RS transmitted over the preceding consecutive period of time.

The control unit 120 may transfer the bundled CSI report to a separate function unit (not illustrated) configured to perform CSI report-based channel estimation such that the separate function unit (not illustrated) uses multiple (M) CSI reports during channel estimation related to the UE 10.

Obviously, if the control unit 120 is directly in charge of the CSI report-based channel estimation function, the control unit 120 may directly perform channel estimation related to the UE 10 by using the bundled CSI report, that is, multiple (M) CSI reports.

In this case, in the present disclosure, even if the downlink channel environment becomes unstable (for example, Doppler spread occurs) due to the environment in which the UE is moving at high speed, it is possible to use a bundled CSI report regarding a bundled CSI-RS over a consecutive period of time in various CSI report-based channel estimation processes. Therefore, accurate channel estimation based on the CSI report becomes possible by enhancing the Doppler estimation efficiency by securing the time-domain density by means of the Doppler spread.

Meanwhile, according to an embodiment of the present disclosure, the above-mentioned transmission of multiple specific RSs (CSI-RSs) and reporting of multiple pieces of CSI (that is, bundled CSI-RS transmission & CIS reporting) may be activated according to the speed at which the UE 10 is moving.

For example, the gNB device 100 of the present disclosure may predict the speed at which UE is moving with regard to each UE.

In the present disclosure, there is no limitation on the manner of predicting the speed at which the UE is moving. As an example, the gNB device 100 may predict the speed at which the UE 10 is moving on the basis of the timing advance (TA) which varies depending on the distance between the gNB device 100 and the UE 10.

The gNB device 100 of the present disclosure may predict the speed at which each UE is moving in various manners (for example, TA-based prediction) and may activate bundled CSI-RS transmission & CIS reporting defined by the present disclosure with regard to UE 10 deemed to be moving at high speed (for example, at a threshold speed or higher, or in a preconfigured range of high-speed movement).

Meanwhile, if UE 10 is moving at high speed, the transmission performance is degraded in most cases due to downlink scheduling performed on the basis of channel estimation through the CSI report of the UE 10. Therefore, if degraded transmission performance due to downlink scheduling based on channel estimation is identified, the UE 10 may be indirectly deemed to be moving at high speed.

Therefore, according to an embodiment of the present disclosure, bundled CSI-RS transmission & CIS reporting may be activated according to a change in transmission performance due to downlink scheduling based on channel estimation regarding UE 10.

For example, the gNB device 100 of the present disclosure may identify transmission performance with regard to each UE transmitting downlink data according to downlink scheduling based on channel estimation through the CSI report.

The gNB device 100 of the present disclosure may activate bundled CSI-RS transmission & CIS reporting defined by the present disclosure with regard to UE 10 deemed to have degraded transmission performance due to a data transmission failure or the like (for example, NACKs transmitted L times due to a transmission failure).

Furthermore, according to an embodiment of the present disclosure, the number of the above-mentioned specific RSs (CSI-RSs) transmitted and the number of CSI reports, that is, the number of times bundled CSI-RS transmission & CIS reporting are conducted, may be determined according to the speed at which the UE 10 is moving.

For example, the gNB device 100 of the present disclosure may determine a larger number (N) of transmitted CRI-RSs and a larger number (M) of CSI reports if the UE 10 which activates bundled CSI-RS transmission & CIS reporting of the present disclosure is moving at a higher speed than when the same is moving at a lower speed such that, the higher the speed the UE is moving at, the larger the number of bundled CSI-RSs transmitted, thereby receiving a larger number of bundled CSI reports.

Meanwhile, according to an embodiment of the present disclosure, the number of the above-mentioned specific RSs (CSI-RSs) transmitted and the number of CSI reports, that is, the number of times bundled CSI-RS transmission & CIS reporting are conducted, may be determined according to a change in transmission performance according to downlink scheduling based on channel estimation regarding the UE 10.

As described above, degradation in transmission performance according to downlink scheduling performed on the basis of channel estimation through the CSI report of the UE 10 is proportional to the speed at which the UE 10 is moving. Therefore, it may be indirectly predicted that the more degradation in transmission performance according to downlink scheduling based on channel estimation, the higher the speed the UE 10 is moving at.

The gNB device 100 of the present disclosure may thus determine a larger number (N) of transmitted CRI-RSs and a larger number (M) of CSI reports, with regard to the UE 10 which activates bundled CSI-RS transmission & CIS reporting of the present disclosure, in proportion to degradation in transmission performance due to a data transmission failure or the like than when degradation in transmission performance is less such that, the higher the speed the UE is indirectly predicted to be moving at, the larger the number of bundled CSI-RSs transmitted, thereby receiving a larger number of bundled CSI reports.

As such, in the present disclosure, bundled CSI-RS transmission & CIS reporting schemes are newly defined such that multiple (N) CSI-RSs are transmitted in a bundle and multiple (M) CSIs are reported in a bundle according to the mobility of UE which is moving at high speed, thereby enabling accurate channel estimation based on the CSI report even in an environment in which the UE is moving at high speed, and in which channel estimation is difficult due to the occurrence of Doppler spread or the like.

Meanwhile, transmission of multiple specific RSs (CSI-RSs) and reporting of multiple CSIs (that is, bundled CSI-RS transmission & CIS reporting) may be activated by a specific identifier transmitted through a field predefined inside configuration information related to a specific RS (CSI-RS) or an additionally defined specific field.

To describe a more specific embodiment, prior to a downlink channel estimation process using a CSI-RS, the gNB basically transmits configuration information (for example, CSI configuration) for this to the UE, and such configuration information (for example, CSI configuration) may include a CSI-RS transmission scheme, the position of a radio resource for transmitting the CSI-RS, CSI report-related information (for example, CSI report config.), and the like.

According to an embodiment of the present disclosure, a specific identifier for “bundled CSI-RS transmission & CIS reporting activation” may be additionally defined such that the same can be used for a CSI report field predefined inside configuration information related to the CSI-RS transmitted to the UE, particularly, CSI report-related information (for example, CSI report config.).

In this case, the gNB device 100 of the present disclosure may activate bundled CSI-RS transmission & CIS reporting by transmitting the specific identifier through the CSI report field predefined inside CSI report-related information (for example, CSI report config.) with regard to UE 10 deemed to be moving at high speed or UE 10 deemed to have degraded transmission performance due to downlink scheduling based on channel estimation.

According to another embodiment of the present disclosure, a specific field (for example, B-CSI-report-Config.) for bundled CSI-RS transmission & CIS reporting may be additionally defined inside configuration information related to the CSI-RS transmitted to the UE, particularly, CSI report-related information (for example, CSI report config.).

In this case, the gNB device 100 of the present disclosure may activate bundled CSI-RS transmission & CIS reporting by transmitting a specific identifier through the specific field (for example, B-CSI-report-Config.) additionally defined inside CSI report-related information (for example, CSI report config.) with regard to UE 10 deemed to be moving at high speed or UE 10 deemed to have degraded transmission performance due to downlink scheduling based on channel estimation.

As described above, embodiments of the present disclosure implement an adaptive channel estimation technology wherein, in connection with a scheme for CSI-RS transmission and CIS reporting, bundled CSI-RS transmission & CIS reporting is newly defined to be performed adaptively according to the mobility of UE, thereby enabling accurate channel estimation based on a CSI report while reflecting the mobility of the UE.

Accordingly, the present disclosure is advantageous in that accurate channel estimation based on a CSI report becomes possible by reflecting the mobility of the UE, thereby minimizing degradation in downlink transmission performance even with regard to UE which is moving at high speed.

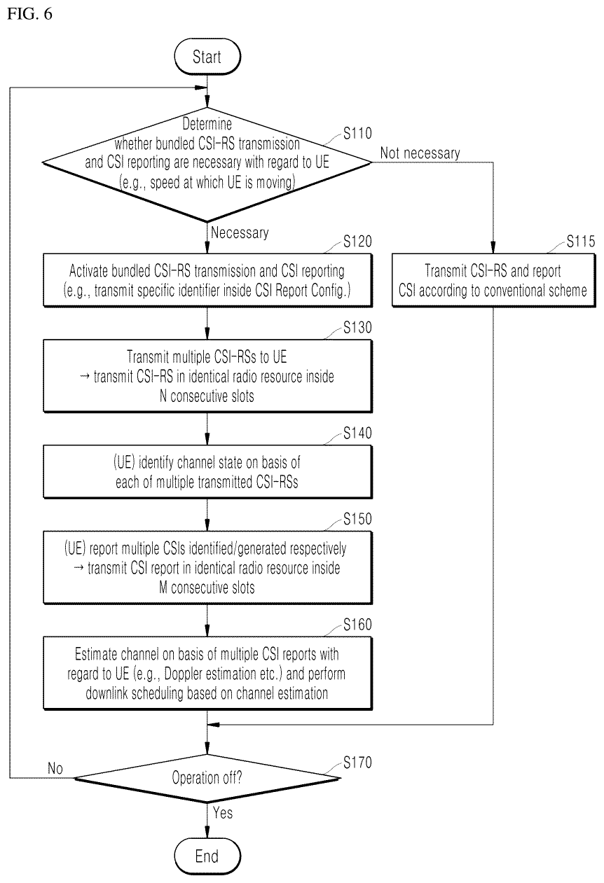

Hereinafter, a method for operating a gNB device according to an embodiment of the present disclosure will be described with reference to FIG. 6.

In the method for operating a gNB device according to an embodiment of the present disclosure, the gNB device 100 determines whether bundled CSI-RS transmission & CIS reporting newly defined by the present disclosure is necessary with regard to each UE which is transmitting downlink data according to downlink scheduling based on channel estimation through a CSI report (S110).

According to an embodiment of the present disclosure, it may be determined that bundled CSI-RS transmission & CIS reporting is necessary with regard to UE 10 deemed to be moving at high speed (for example, at a threshold speed or higher, or in a preconfigured range of high-speed movement) by predicting the speed at which each UE is moving in various manners (for example, TA-based prediction).

According to another embodiment of the present disclosure, it may be determined that bundled CSI-RS transmission & CIS reporting is necessary with regard to UE 10 deemed to have degraded transmission performance due to downlink scheduling based on channel estimation (for example, NACKs transmitted L times due to a transmission failure).

In the method for operating a gNB device according to an embodiment of the present disclosure, the gNB device 100 may transmit a specific identifier through a field predefined inside configuration information related to a CSI-RS, particularly, CSI report-related information (for example, CSI report config.), or an additionally defined specific field with regard to UE 10 deemed to need bundled CSI-RS transmission & CIS reporting, thereby activating bundled CSI-RS transmission & CIS reporting of the present disclosure with regard to the UE 10 (S120).

According to an embodiment of the present disclosure, bundled CSI-RS transmission & CIS reporting may be activated by transmitting a specific identifier through a CSI report field predefined inside CSI report-related information (for example, CSI report config.) with regard to UE 10.

According to another embodiment of the present disclosure, bundled CSI-RS transmission & CIS reporting may be activated by additionally defining a specific field (for example, B-CSI-report-Config.) for bundled CSI-RS transmission & CIS reporting inside CSI report-related information (for example, CSI report config.) and transmitting a specific identified through the additionally defined specific field (for example, B-CSI-report-Config.), with regard to UE 10.

Thereafter, in the method for operating a gNB device according to an embodiment of the present disclosure, the gNB device 100 may transmit multiple (N) CSI-RSs over a consecutive period of time with regard to UE 10 for which bundled CSI-RS transmission & CIS reporting has been activated, thereby transmitting multiple (N) CSI-RSs in a bundle (S130).

Specifically, the gNB device 100 may transmit CSI-RSs through identical pre-allocated radio resources inside multiple (for example, N) slots over a consecutive period of time in a PDSCH such that multiple (N) CSI-RSs are transmitted over a consecutive period of time (bundled transmission) (S130).

In the present disclosure, upon receiving the multiple (N) CSI-RSs transmitted by the gNB 100 in a bundle, the UE 10 identifies/recognizes the channel status on the basis of each CSI-RS (S140). The UE 10 reports a bundle of multiple (M) CSIs generated by recognizing the channel status on the basis of respective CSI-RSs (S150).

For example, the UE 10 may transmit multiple (N) CSI reports generated by recognizing the channel status on the basis of respective CSI-RSs through identical pre-allocated radio resources inside multiple (for example, M) slots over a consecutive period of time in a PDSCH such that multiple (M) CSI reports are transmitted over a consecutive period of time, thereby implementing bundle-type reporting.

In the method for operating a gNB device according to an embodiment of the present disclosure, the gNB device 100 may receive a bundled CSI report regarding the bundled CSI-RS transmitted previously over a consecutive period of time from the UE 10 which is supposed to receive multiple (N) CSI-RSs transmitted in a bundle.

In the method for operating a gNB device according to an embodiment of the present disclosure, the gNB device 100 may directly perform channel estimation based on a CSI report with regard to the UE 10 by using a bundled CSI report, that is, multiple (M) CSI reports.

In the method for operating a gNB device according to an embodiment of the present disclosure, the gNB device 100 may then use the bundled CSI report regarding the bundled CSI-RS over a consecutive period of time in various processes of CSI report-based channel estimation with regard to the UE 10 which is moving at high speed (S160).

As such, in the method for operating a gNB device according to an embodiment of the present disclosure, the gNB device 100 may use the bundled CSI report regarding the bundled CSI-RS in various processes of CSI report-based channel estimation such that the efficiency of Doppler estimation is enhanced by securing time-domain density by means of Doppler spread. As a result, accurate channel estimation based on a CSI report becomes possible, and downlink scheduling (for example, modulation scheme, code rate, the number of transmission layers, MIMO precoding, and the like) may be performed on the basis of accurate channel estimation (S160).

In the method for operating a gNB device according to an embodiment of the present disclosure, the gNB device 100 may continuously perform above-described operation S110 and following operations as long as the bundled CSI-RS transmission & CIS reporting operation of the present disclosure is not turned off (NO in S170).

As described above, in the method for operating a gNB device according to an embodiment of the present disclosure, an adaptive channel estimation technology is implemented wherein, in connection with a scheme for CSI-RS transmission and CIS reporting, bundled CSI-RS transmission & CIS reporting is newly defined to be performed adaptively according to the mobility of UE, thereby enabling accurate channel estimation based on a CSI report while reflecting the mobility of the UE.

Accordingly, the present disclosure is advantageous in that accurate channel estimation based on a CSI report becomes possible by reflecting the mobility of the UE, thereby minimizing degradation in downlink transmission performance even with regard to UE which is moving at high speed.

Meanwhile, the present disclosure may also implement the proposed adaptive channel estimation technology by newly defining adaptive CSI reporting initiated by UE (hereinafter, referred to as UE-initiated CSI feedback) by reflecting the mobility of the UE, in connection with a CSI reporting scheme.

Hereinafter, UE-initiated CSI feedback reflecting the mobility of UE, which is to be newly defined/implemented by the present disclosure, will be described in detail.

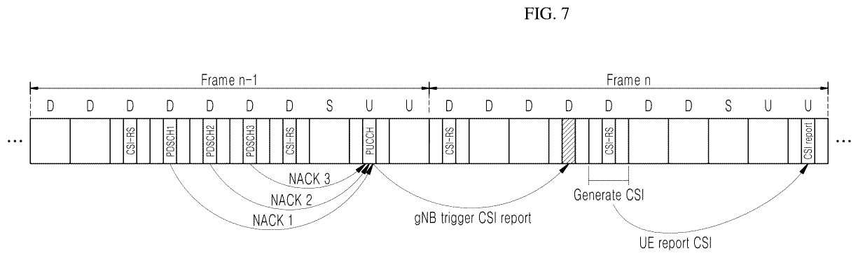

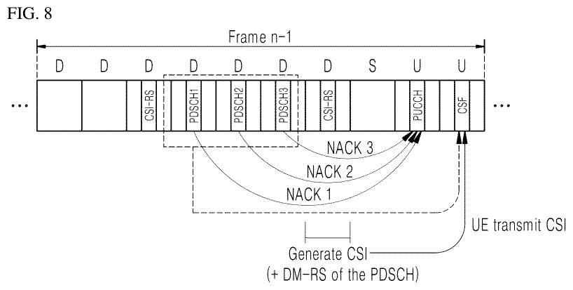

The concept regrading UE-initiated CSI feedback defined by the present disclosure may be described briefly with reference to FIG. 7 and FIG. 8.

Conventionally, if a gNB transmits a CSI-RS, UE receives the same and transmits a CSI report by using time and frequency radio resources mapped to a CSI-RS. The gNB may perform channel estimation on the basis of the CSI report with regard to the UE, thereby performing downlink scheduling based on channel estimation.

However, except for a case in which a CSI report is defined for each frame, there may be a problem in that, even if transmission performance is degraded during downlink data transmission, the degradation in downlink transmission performance is continuously generated/maintained until a CSI report is transmitted, because the CSI reporting timepoint is delayed, as in clear from FIG. 7.

For example, FIG. 7 illustrates multiple (for example, L) occurrences of a transmission failure (NACK) in the same Frame (n−1) due to rate adaptation mismatch in connection with downlink scheduling based on channel estimation.

In this case, conventionally, if the UE reports a downlink transmission failure (NACK) to the gNB, the gNB transfers a CSI report trigger such that the UE transmits a CSI report, thereby making it possible to re-perform channel estimation on the basis of the CSI report and to re-perform downlink scheduling based on channel estimation.

That is, conventionally, even if a downlink transmission failure (NACK) occurs in the same Frame (n−1), the CSI report is not transmitted in the same Frame (n−1) but is transmitted in the UL channel of the next Frame (n).

As a result, downlink transmission through the next Frame (n), which is prior to transmission of the CSI report, follows previous channel estimation-based downlink scheduling. The rate adaptation mismatch still occurs, thereby increasing the possibility that the transmission failure will continue.

Therefore, a UE-initiated CSI feedback scheme is proposed, as illustrated in FIG. 8, such that if a downlink transmission failure (NACK) occurs in Frame (n−1), the UE recognizes the same and actively transmit the latest CIS in the same Frame (n−1).

That is, in the present disclosure, upon recognizing degradation in downlink transmission performance (for example, downlink transmission failure), the UE may actively generate and transmit a CSI in the same frame in which performance degradation is recognized.

Meanwhile, if the UE is moving at high speed, downlink channel environments become unstable due to the occurrence of Doppler spread or the like, and the accuracy of channel estimation through a CSI report in unstable environments is inevitably degraded according to conventional schemes, thereby increasing the possibility that rate adaption mismatch will occur in connection with channel estimation-based downlink scheduling.

Consequently, in the present disclosure, based on the fact that channel estimation-based downlink transmission performance is degraded during a high-speed movement of UE, the UE (which is highly likely to be moving at high speed) recognizes degradation in downlink transmission performance (for example, downlink transmission failure) and actively transmits a CSI in the same frame in which the same is recognized, thereby enabling accurate channel estimation at an appropriate/early timepoint on the basis of CSI feedback transmitted by the UE moving at high speed.

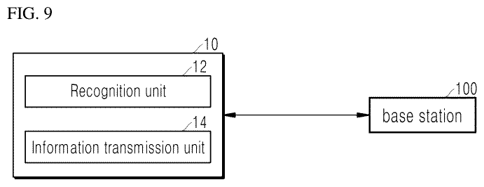

Hereinafter, components of a UE device according to an embodiment of the present disclosure will be described in detail with reference to FIG. 9.

As illustrated in FIG. 9, the UE device 10 according to an embodiment of the present disclosure may include a recognition unit 12 and an information transmission unit 14.

Moreover, the UE device 10 according to an embodiment of the present disclosure may further include a communication unit (not illustrated) configured to communicate with a gNB 100 in addition to the above-mentioned components.

The communication unit (not illustrated) includes, for example, an antenna system, an RF transceiver, one or more amplifiers, a tuner, one or more oscillators, a digital signal processor, a codec chipset, a memory, and the like, but is not limited thereto, and may include all known circuits configured to perform these functions.

All or at least some of the components of the UE device 100 may be implemented as hardware modules, software modules, or combinations of hardware modules and software modules.

As used herein, a software module may be understood as an instruction executed by a processor that controls operations inside the UE device 10, for example, and such an instruction may be mounted in a memory inside the UE device 10.

Consequently, the UE device 10 according to an embodiment of the present disclosure implements UE-initiated CSI feedback to be defined by the present disclosure, through the above-mentioned components. Hereinafter, respective components of the UE device 10 for implementing this will be described in more detail.

The recognition unit 12 is configured to recognize a data transmission failure situation according to downlink scheduling based on channel estimation.

To be more specific, the recognition unit 12 may recognize the data transmission failure situation according to the ratio of transmitted NACKs against data transmitted through a downlink channel in the same frame.

For example, with reference to FIG. 8, the recognition unit 12 may recognize a data transmission failure situation on the basis of a transmission failure (NACK) transmitted after an error check (for example, cyclic redundancy check (CRC)) regarding data transmitted through a downlink channel (that is, PDSCH) in the same frame, with regard to each frame.

As an example, if the ratio of transmission failures (NACK) transmitted in the same frame is equal to/larger than a preconfigured setting value (for example, L times), the recognition unit 12 may recognize a data transmission failure situation according to downlink scheduling based on channel estimation.

The information transmission unit 14 is configured such that, if the recognition unit 12 recognizes data transmission failure situation, CSI regarding the downlink channel is transmitted to the gNB 100 through the fastest uplink channel at the current recognition timepoint, thereby enabling the gNB 100 to perform downlink scheduling based on channel estimation by using the CSI.

The fastest uplink channel at the current recognition timepoint may be defined as a reserved channel inside a physical uplink control channel (PUCCH) or physical uplink shared channel (PUSCH) inside the same frame in which the data transmission failure situation is recognized.

That is, with reference to FIG. 8, the present disclosure may additionally define CSI transmission according to UE-initiated CSI feedback of the present disclosure in an available reserved channel inside the PUCCH or PUSCH with regard to each frame.

If the recognition unit 12 recognizes a downlink transmission failure situation (for example, NACK occurring L (L=3) times) in frame (n−1), the information transmission unit 14 may generate the latest CSI regarding the downlink channel and may transmit the CSI to the gNB 100 through a reserved channel inside the PUCCH or PUSCH defined for CSI transmission in the same frame (n−1) in which the data transmission failure situation is recognized.

The information transmission unit 14 may generate the latest CSI regarding the downlink channel on the basis of at least one of a CSI-RS and a DM-RS received inside the same frame (n−1) in which the data transmission failure situation is recognized.

As an example, the information transmission unit 14 may generate the CSI regarding the downlink channel on the basis of the latest CSI-RS which was not used as a basis when generating the previous CSI report, and this may be transmitted to the gNB 100 through a reserved channel of the PUCCH or PUSCH in the same frame (n−1) in which the data transmission failure situation is recognized.

To describe a more specific embodiment, the information transmission unit 14 may generate the CSI regarding the downlink channel on the basis of a continuous DM-RS included in the PDSCH, as well as the latest CSI-RS which was not used as a basis when generating the previous CSI report.

In addition, the information transmission unit 14 may transmit the CSI generated in this manner to the gNB 100 through a reserved channel of the PUCCH or PUSCH in the same frame (n−1) in which the data transmission failure situation is recognized.

Obviously, the information transmission unit 14 may generate the CSI regarding the downlink channel on the basis of only the continuous DM-RS included in the PDSCH, and may transmit this to the gNB 100 through the reserved channel of the PUCCH or PUSCH in the same frame (n−1) in which the data transmission failure situation is recognized.

In such a case, according to the present disclosure, the UE (which is highly likely to be moving at high speed) may recognize degradation in downlink transmission performance (for example, downlink transmission failure) and actively transmit a CSI in the same frame in which the same is recognized, thereby enabling the gNB 100 to perform accurate channel estimation at an appropriate/early timepoint on the basis of CSI feedback transmitted by the UE moving at high speed.

As described above, based on the fact that channel estimation-based downlink transmission performance is degraded during a high-speed movement of UE, the UE device according to an embodiment of the present disclosure newly defines UE-initiated CSI feedback such that the UE actively generates and transmits CSI at an appropriate/early timepoint while reflecting the mobility of the UE, thereby implementing an adaptive channel estimation technology in which accurate channel estimation based on CSI feedback becomes possible by reflecting the mobility of the UE.

Accordingly, the present disclosure is advantageous in that accurate channel estimation based on CSI feedback transmitted at an appropriate/early timepoint by UE moving at high speed becomes possible while reflecting the mobility of the UE, thereby minimizing degradation in downlink transmission performance even with regard to UE which is moving at high speed.

Meanwhile, the above-mentioned “CSI report” and “CSI feedback” have the role of being used by the gNB during channel estimation regarding the downlink channel of the UE, and “CSI report” and “CSI feedback” are differently used according to whether “UE-initiated” or not.

Moreover, two technologies proposed by the present disclosure, that is, bundled CSI-RS transmission & CIS reporting and UE-initiated CSI feedback, may be separately implemented, or the two technologies proposed by the present disclosure may be both implemented in the same system.

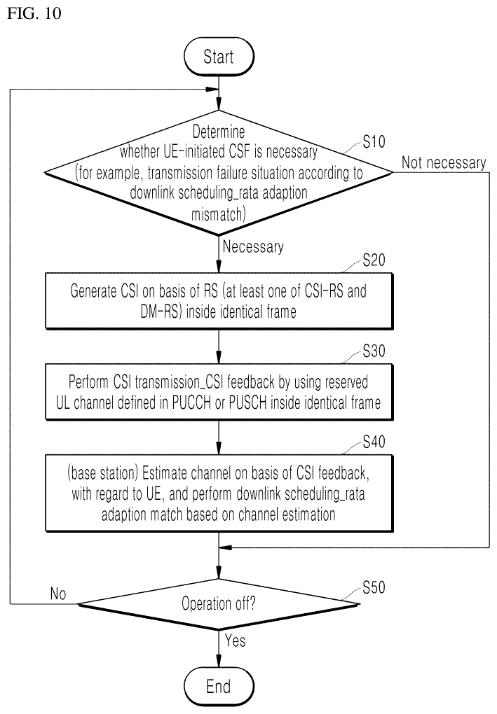

Hereinafter, a method for operating a UE device according to an embodiment of the present disclosure will be described with reference to FIG. 10.

In the method for operating a UE device according to an embodiment of the present disclosure, the UE device 10 determines whether UE-initiated CSI feedback newly defined by the present disclosure is necessary (S10).

According to an embodiment, the UE device 10 may determine that UE-initiated CSI feedback is necessary, upon recognizing a data transmission failure situation according to downlink scheduling based on channel estimation.

Specifically, for example, in the present disclosure, a data transmission failure situation according to downlink scheduling based on channel estimation may be recognized if the ratio of transmission failures (NACK) transmitted in the same frame is equal to/larger than a preconfigured setting value (for example, L times), on the basis of a transmission failure (NACK) transmitted after an error check (for example, cyclic redundancy check (CRC)) regarding data transmitted through a downlink channel (that is, PDSCH) in the same frame, with regard to each frame.

In the method for operating a UE device according to an embodiment of the present disclosure, the UE device 10 generates the latest CSI regarding the downlink channel upon recognizing a data transmission failure situation and thus determining that UE-initiated CSI feedback is necessary (S20).

To be specific, referring to FIG. 8, if a downlink transmission failure situation (for example, NACK occurring L (L=3) times) is recognized in frame (n−1), the UE device 10 may generate the latest CSI regarding the downlink channel on the basis of at least one of a CSI-RS and a DM-RS received inside the same frame (n−1) in which the data transmission failure situation is recognized.

To describe a more specific embodiment, the UE device 10 may generate the CSI regarding the downlink channel on the basis of the latest CSI-RS which was not used as a basis when generating the previous CSI report, and a continuous DM-RS included in the PDSCH, in the same frame (n−1) in which the data transmission failure situation is recognized.

In the method for operating a UE device according to an embodiment of the present disclosure, the UE device 10 may transmit the CSI regarding the downlink channel generated in operation S20 to the gNB 100 through a predefined reserved channel of the PUCCH or PUSCH in the same frame (n−1) in which the current data transmission failure situation is recognized (S30).

That is, in the present disclosure, upon recognizing degradation in downlink transmission performance (for example, downlink transmission failure), the UE (which is highly likely to be moving at high speed) actively generates and transmits a CSI in the same frame in which this is recognized.

In this manner, the gNB 100 in the present disclosure can perform accurate channel estimation at an appropriate/early timepoint on the basis of CSI feedback transmitted by the UE moving at high speed, thereby making it possible to re-perform downlink scheduling based on channel estimation at an appropriate/early timepoint (S40).

In the method for operating a UE device according to an embodiment of the present disclosure, the UE device 10 may continuously perform above-described operation S10 and following operations as long as the UE-initiated CSI feedback operation of the present disclosure is not turned off (NO in S50).

As described above, in the method for operating a UE device according to an embodiment of the present disclosure, UE-initiated CSI feedback is newly defined such that, based on the fact that channel estimation-based downlink transmission performance is degraded during a high-speed movement of UE, the UE actively generates and transmits CSI at an appropriate/early timepoint while reflecting the mobility of the UE, thereby implementing an adaptive channel estimation technology in which accurate channel estimation based on CSI feedback becomes possible by reflecting the mobility of the UE.

Accordingly, the present disclosure is advantageous in that accurate channel estimation based on CSI feedback transmitted at an appropriate/early timepoint by UE moving at high speed becomes possible while reflecting the mobility of the UE, thereby minimizing degradation in downlink transmission performance even with regard to UE which is moving at high speed.

A method for operating a gNB device and a method for operating a UE device according to an embodiment of the present disclosure may be implemented as program commands which may be performed through various computer means and recorded in a computer-readable medium. The computer-readable medium may include program commands, data files, data structures, and the like alone or in combination. Program commands recorded in the medium may be specially designed and configured for the present disclosure, or widely known and available to those skilled in the art regarding computer software. Examples of the computer-readable medium include magnetic media such as a hard disk, a floppy disk, and a magnetic tape, optical media such as a CD-ROM and a DVD, magneto-optical media such as a floptical disk, and hardware devices specially configured to store and perform program commands, such as a ROM, a RAM, and a flash memory. Examples of the program commands include not only machine language codes such as those made by compilers, but also high-level language codes which can be executed by computers by using interpreters or the like. The hardware device may be configured to operate as one or more software modules in order to perform operations of the present disclosure, and vice versa.

Although the present disclosure has been described in detail with reference to exemplary embodiments, the present disclosure is not limited to the above-described embodiments, and the technical idea of the present disclosure is to be understood as encompassing various modifications or changes which those skilled in the art to which the present disclosure pertains can make without deviating from the gist of the present disclosure defined in the accompanying claims.

1. A base station device comprising:
a reference signal multi-transmission unit configured to transmit multiple specific reference signals (RSs) over a consecutive period of time; and
a control unit configured to receive multiple channel state information on the basis of each of the multiple specific RSs from UE which has received the multiple specific RSs such that the multiple channel state information are used for channel estimation regarding the UE.

2. The base station device of claim 1, wherein transmission of the multiple specific RSs and reporting of the multiple channel state information are activated by a specific identifier transmitted through a predefined field in configuration information related to the specific RSs, or an additionally defined specific field.

3. The base station device of claim 1, wherein the reference signal multi-transmission unit is configured to transmit the specific RSs through radio resources in multiple slots over the consecutive period of time for transmitting multiple specific RSs over the consecutive period of time.

4. The base station device of claim 1, wherein transmission of the multiple specific RSs and reporting of the multiple channel state information are activated based on the speed at which the UE is moving, or activated based on a change in transmission performance according to downlink scheduling based on channel estimation regarding the UE.

5. The base station device of claim 1, wherein the number of the multiple specific RSs and the multiple channel state information is larger in proportion to the speed at which the UE is moving, or larger in proportion to degradation in transmission performance according to downlink scheduling based on channel estimation regarding the UE.

6. A method for operating a base station device, the method comprising:
transmitting multiple specific reference signals (RSs) over a consecutive period of time; and
receiving multiple channel state information on the basis of each of the multiple specific RSs from UE which has received the multiple specific RSs such that the multiple channel state information are used for channel estimation regarding the UE.

7. The method for operating a base station device of claim 6, wherein transmission of the multiple specific RSs and reporting of the multiple channel state information are activated by a specific identifier transmitted through a predefined field in configuration information related to the specific RSs, or an additionally defined specific field.

8. The method for operating a base station device of claim 6, wherein transmission of the multiple specific RSs and reporting of the multiple channel state information are activated based on the speed at which the UE is moving, or activated based on a change in transmission performance according to downlink scheduling based on channel estimation regarding the UE.
